(19) United States
(12) Patent Application Publication
(10) Pub. No.: US 2005/0076173 A1
(43) Pub. Date: Apr. 7, 2005

(54) Method and apparatus for preconditioning data to be transferred on a switched underlay network

(75) Inventors: Steve Merril, Los Altos, CA (US); William Douglas Cutrell, San Francisco, CA (US); Howard J. Cohen, Palo Alto, CA (US); Tal Lavian, Sunnyvale, CA (US)

Correspondence Address: JOHN C. GORECKI, ESQ., 180 HEMLOCK HILL ROAD, CARLISLE, MA, 01741, US

(73) Assignee: Nortel Networks Limited, St. Laurent (CA)

(21) Appl. No.: 10/812,634

(22) Filed: Mar. 30, 2004

Related U.S. Application Data
(63) Continuation-in-part of application No. 10/719,225, filed on Nov. 21, 2003.
(60) Provisional application No. 60/508,524, filed on Oct. 3, 2003.
(60) Provisional application No. 60/508,524, filed on Oct. 3, 2003.

(51) Int. Cl. G06F 12/00

(52) U.S. Cl. 711/100

(57) ABSTRACT

Data may be preconditioned to be transferred on a switched underlay network to alleviate the data access and transfer rate mismatch, so that large files may be effectively transferred on the network at optical networking speeds. A data meta-manager service may be provided on the network to interface a data source and/or data target to prepare a data file for transmission, such as by dividing a large file into multiple pieces and causing those pieces to be stored on multiple storage subsystems. The file may then be read from the multiple storage subsystems simultaneously and multiplexed onto scheduled resources on the network. This enables the high bandwidth transfer resource to be filled by a data transfer without requiring the storage subsystem to be augmented to output the data at the network transfer rate. The file may be de-multiplexed at the data target to one or more storage subsystems.

### CROSS REFERENCE TO RELATED APPLICATIONS

This application is a continuation in part of Provisional U.S. Patent Application No. 60/508,522, filed Oct. 3, 2003, and is also a continuation in part of U.S. patent application Ser. No. 10/719,225, filed Nov. 21, 2003, the content of each of which is hereby incorporated herein by reference. This application is also related to U.S. patent Application entitled Method and Apparatus for Automated Negotiation For Resources on a Switched Underlay Network, filed concurrently herewith, the content of which is hereby incorporated by reference.

### BACKGROUND

1. Field

This application relates to communication networks and, more particularly, to a method and apparatus for preconditioning data to be transferred on a switched underlay network.

2. Description of the Related Art

Data communication networks may include various computers, servers, nodes, routers, switches, hubs, proxies, and other devices coupled to and configured to pass data to one another. These devices will be referred to herein as “network elements,” and may provide a variety of network resources such as communication links and bandwidths. Conventionally, data has been communicated through the data communication networks by passing protocol data units (or cells, frames, or segments) between the network elements by utilizing one or more type of network resources. A particular protocol data unit may be handled by multiple network elements and cross multiple communication links as it travels between its source and its destination over the network.

Conventional data networks are packet switched networks, in which data is transmitted in packet form which allows the packets to be commingled with other packets from other network subscribers. As the size of a data transfer increases in size, the ability to handle the data transfer on a packet network decreases. For example, a traditional packet switched network, such as a TCP/IP based communication network, will tend to become overloaded and incapable or inefficient at handling large data transfers. Thus, it is desirable, at least in large transfers, to obtain a dedicated path through the network to handle the transfer.

Grid networks is one emerging application in which it may be desirable to obtain switched network resources to handle transfers between network participants. Grid networks is a technology that may be used to build an overlay network, i.e. a computational Grid, on an existing network infrastructure using Grid computing technology. In a Grid network, which forms a virtual organization, Grid nodes are distributed widely and share computational resources such as disk storage, storage servers, shared memory, computer clusters, data mining, and visualization centers, although other resources may be available as well. One example of Grids is the TeraGrid, in which Grid computing technology has been deployed to enable supercomputer clusters distributed in four distant locations in the United States to collaboratively work on computationally intense tasks, such as high-energy physics simulations and long-term global weather forecasting. Other potential uses for Grid computing include genomics, protein structure research, computational fluid dynamics, astronomy and astrophysics, Search for ExtraTerrestrial Intelligence (SETI), computational chemistry, “intelligent” drug design, electronic design automation, nuclear physics, and high-energy physics. Grid computing may be used for many other purposes as well, and this list is not intended to be inclusive of all possible uses.

Some of these applications are or are expected to be capable of producing an incredible amount of data that will need to be distributed to other Grid applications for analysis. For example, high energy physics experiments expected to begin in 2007 are expected to produce data at a rate that may exceed one petabyte of data per year (1 petabyte=1000 Terabyte=10¹⁵ bytes). This data will need to be sent to many different sites, such as research facilities and universities around the world, for analysis and storage.

One technology that is capable of handling these large data transfers is the use of switched optical networking. Typically, each transfer, which is typically several hundred gigabytes to several terabytes in size, uses a dedicated switched optical link. These links are typically provisioned to operate at 10 gigabits/second over each dedicated wavelength (lambda), and multiple lambdas can be multiplexed together to provide bandwidth sufficient to transfer these vast quantities of data.

Conventionally, large data files have been stored on disk drives and other storage systems having a data output rate of up to about 10 Megabits per second (Mbps). Striping techniques, and other techniques, may enable this to increase to up to 100 Mbps, and large storage systems, such as the EMC Celerra Clustered Network Server™ storage system, may increase the data output rate to up to 1-4 gigabits per second. While these storage systems may be scaled to store hundreds of terabytes of data, the data output rate from the storage system may be one or more orders of magnitude slower than the transfer rate of the switched underlay network, especially when several 10 Gbps lambdas are aggregated to handle the transfer.

### SUMMARY OF THE DISCLOSURE

As described in greater detail herein, a method and apparatus for preconditioning data to be transferred on a switched underlay network alleviates the data access and transfer rate mismatch so that large files may be effectively transferred on the network. According to one embodiment of the invention, one or more storage meta-managers are provided on the network to interface data source and data target resources to prepare the data files for transmission over the network. Specifically, when a large file is to be transferred over a fast connection, e.g. an optical channel, the meta-manager may precondition the file to be transferred by breaking it into multiple pieces and distributing those pieces between multiple storage subsystems, each of which has access to a network element with access to the switched underlay network resource. When the data has been distributed and is ready to be transferred, the storage resources begin reading and simultaneously provide the data to the network element. The network element multiplexes the data onto the optical channel or otherwise makes the data available to the switched data resource so that the data may be provided at a higher data rate. The file is then passed across the network over the switched underlay network resources and a similar process de-multiplexes the data on the data target end. In this manner a meta-manager may effect the transfer of large files across the network at high data rates using lower data rate storage systems. The data once transferred may optionally be collected and reconditioned into a single file for use by computation and other resources at the data target. The storage resources may be associated with the network element or may be independent of the network element and connected to the network element.

### BRIEF DESCRIPTION OF THE DRAWINGS

Aspects of the present invention are pointed out with particularity in the claims. The following drawings disclose one or more embodiments for purposes of illustration only and are not intended to limit the scope of the invention. In the following drawings, like references indicate similar elements. For purposes of clarity, not every element may be labeled in every figure. In the figures:

FIG. 1 is a functional block diagram of an example of a communication network including a data transfer scheduling service, resource negotiation service, and data meta-manager service, according to an embodiment of the invention;

FIG. 2 is a functional block diagram of a data transfer scheduling service network architecture according to an embodiment of the invention;

FIG. 3 is a functional block diagram of the data transfer scheduling service network architecture of FIG. 2 in greater detail according to an embodiment of the invention;

FIG. 4 is a flow diagram illustrating a process of interfacing users to a data transfer scheduling service to obtain communication resources, for example on the network architecture of FIGS. 2 and 3, according to an embodiment of the invention;

FIG. 5 is a functional block diagram of a resource negotiation service according to an embodiment of the invention;

FIG. 6 is a functional block diagram of a data management service according to an embodiment of the invention;

FIG. 7 is a functional block diagram of a network resources manager according to an embodiment of the invention;

FIG. 8 is a functional block diagram of a network architecture illustrating the data meta-manager service in greater detail according to an embodiment of the invention;

FIG. 9 is a flow diagram illustrating a process of managing storage resources to optimize data transfers on a switched underlay network according to an embodiment of the invention; and

FIG. 10 is a functional block diagram of a meta-manager according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

FIG. 1 illustrates an example communication network architecture according to an embodiment of the invention in which a resource negotiation service 10 is configured to negotiate between a client application 12 and a network 14 to obtain switched underlay network resources to satisfy the client's request. In the embodiment illustrated in FIG. 1, the resource negotiation service 10 is interposed between the client application 12 and a data transfer scheduling service 16, which abstracts the network for the resource negotiation service and fulfills negotiated requests on behalf of the client application. For example, the data transfer scheduling service 16 may be configured to schedule transfers of data between a data source 18 and a data target 20 and secure appropriate network resources to fulfill the request on the switched underlay network 14. The data source and data target may be associated with ftp server daemons configured to send and receive data on demand. In this embodiment, the client application 12 is configured to request the transfer of data from the data source 18 to the data target 14 and need not be associated with either the source or the target. The request will be negotiated by the resource negotiation service and, upon negotiation of the request, the data transfer scheduling service will schedule the request as described in greater detail below. Optionally, one or more meta-managers forming a data meta-managing service 38 may be used to pre-condition the data for transfer over the network at the scheduled time on the scheduled resources.

Negotiation between the client application and the data transfer scheduling service enables business logic to be interjected into the process of obtaining network resources on the underlying switched network. For example, a network subscriber may need to back up its data from one site to another site over the network, and may wish to obtain a dedicated path through the network to do so quickly and efficiently. The client may be relatively cost conscious and relatively insensitive as to when the backup occurs as long as it occurs within a set period of time, e.g. before 7 AM the next day. The network operator may desire to maintain the network resources available during peak periods of time to support general packet traffic, and may have excess capacity it would like to sell at other times, such as in the middle of the night. The network operator may desire to price its services accordingly to encourage network subscribers to perform large data transfers when the network is not otherwise being used.

According to an embodiment of the invention, the business logic is implemented as policy in a resource negotiation service interposed between the network and the client applications. FIG. 1 illustrates a process of a request on the network according to an embodiment of the invention. As shown in FIG. 1, an application (not shown) seeking to effectuate the transfer of data from a data source 18 to a data target 20 interfaces a data transfer client application 12 which issues a request to a resource negotiation service or to a data transfer scheduling service (arrow 1). Where the resource negotiation service does not have stored policy information for the client application, the resource negotiation service may obtain the subscriber's policy information. Optionally, the request may contain the policy information to enable the resource negotiation service to understand the requirements and preferences of the client application.

In the embodiment of FIG. 1, the resource negotiation service is illustrated as separate from the data transfer scheduling service 16. This separation is intended to enable the different functions performed by these entities to be illustrated more readily. When implemented, the resource negotiation service may be formed as part of the data transfer scheduling service, e.g. as an interface to the client application, and included with the data transfer scheduling service. Alternatively, the resource negotiation service may be maintained on the client application or on another network construct. Accordingly, the resource negotiation service may be maintained in many locations on the network and the invention is not limited to implementation of the resource negotiation service in any particular location. According to one embodiment of the invention, the resource negotiation service is implemented as a web service configured to support computer-to-computer transactions over a communication network. The invention is not limited in this manner, however.

There are many ways the request may be provided to the resource negotiation service. For example, the request may be addressed to the resource negotiation service, the request may be addressed to the data transfer scheduling service and intercepted by the resource negotiation service, or may be addressed to the data transfer scheduling service, received by the data transfer scheduling service and redirected to the resource negotiation service, or may be routed to the resource negotiation service in another manner.

The resource negotiation service receives the request and interrogates the data transfer scheduling service 16 as to the availability of network resources to fulfill the request (arrow 2). According to an embodiment of the invention, the current state or the anticipated state may be considered in making the policy decision and pricing decisions associated with negotiating bandwidth on the network. For example, the network operator may wish to charge more for bandwidth during periods of high demand or anticipated high demand, and may wish to charge less for bandwidth during other periods to encourage subscribers to use the network at less popular times. To enable this to occur, the current and/or anticipated state of the network may be considered by the resource negotiation service. Additionally, the availability of the network may also be provided so that the resource negotiation service may take into account current and scheduled network outages when allocating resources to fulfill requests.

The data transfer scheduling service interrogates the network if necessary and responds to the resource negotiation service with the current state of the network, the anticipated state of the network to handle the request during the time period specified in the request, or with other parameters that may be used by the resource negotiation service to negotiate fulfillment of the request (arrow 2′). As discussed in greater detail below, the data transfer scheduling service 16 maintains a schedule of transfers to take place on the network, historical usage information, and other network usage information. This information or a summarized form of this information may be provided to the resource negotiation service to enable it to negotiate the request with the client application. Information about the network obtained from the data transfer scheduling service will be referred to herein as “network state information.”

Once the resource negotiation service 10 has received the request parameters and client policy information, and the network state information and policy information from the network, the resource negotiation service will perform an automated negotiation of switched underlay network resources to determine which available network resources will fulfill the request in an optimum fashion. Optionally, the negotiated resource allocation may be communicated to the client application (arrow 3) to enable the client application to confirm (arrow 3′) that the proposed allocation will be acceptable, both in terms of quality (time, quantity, etc.) and price. The ability to confirm the result of the negotiation may be one aspect of client policy that may be set by the client.

Once the negotiation has completed and the client application has optionally confirmed the result of the negotiation, the resource negotiation service communicates the negotiated request to the data transfer scheduling service 16 (arrow 4) to cause the data transfer scheduling service to implement the request on the network.

Upon receipt of the request, the data transfer scheduling service interfaces the network 14 to reserve resources on the network to facilitate the data transfer (arrow 5) and coordinates with the data source (arrow 6) and data target (arrow 7) to arrange for the data to be available at the data source 18, and to arrange the capacity to receive the data at the data target 20. The data transfer scheduling service may also contact the data meta-manager service 38 to cause the data to be pre-conditioned for transfer over the network, as described in greater detail below. The data transfer scheduling service may coordinate with the network resources, data meta-manager service, data source, and data target in any desired order and the invention is not limited to interfacing with these components in any particular order. The data transfer scheduling service 10 may also inform the client application 12 of the status of the transfer (arrow 8) once the transfer is scheduled, upon commencement of the transfer, or at any other stage during the process.

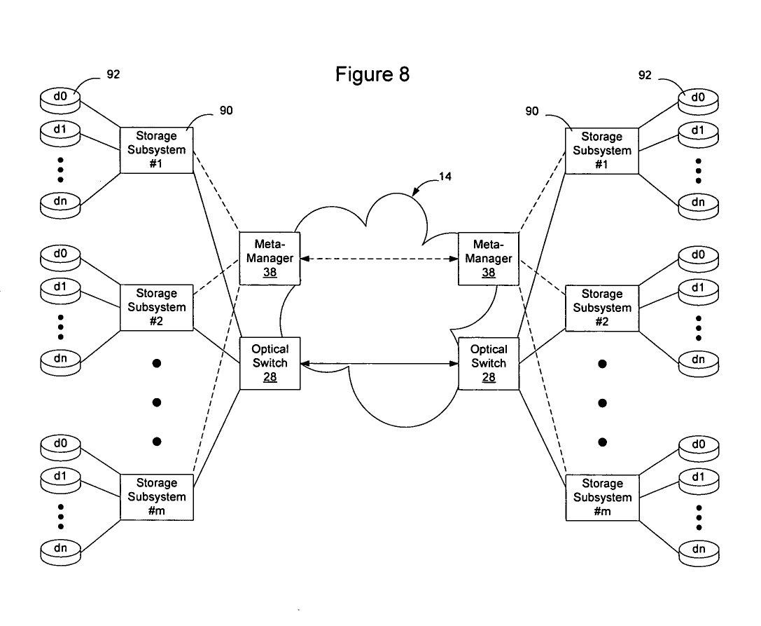

According to one embodiment of the invention, a data meta-manager service may be provided to prepare the data to be transported over the network. For example, the data may exist on a relatively slow disk drive system or a tape storage system that is capable of transferring data at a rate much slower than that available on the resource to be provided on the switched underlay network. Currently, large storage systems may be capable of delivering data at over 1 Gbps. However, optical network resources may be allocated in groups of 10 Gbps, which may be aggregated to provide connectivity in excess of 100 Gbps. Even the largest storage systems thus may be incapable of providing data fast enough to fill the available bandwidth that may be reserved for the transfer. In this event, it may be advantageous to precondition the data, as described in greater detail below in connection with FIGS. 8-10, to position the data on multiple storage subsystems so that the data may be read out of the multiple subsystems simultaneously to thereby provide a higher effective data transfer rate. Preconditioning may also include positioning the data closer the end of the switched underlay network resources so that it may be transferred to the resources at a higher rate, and via other mechanisms. The invention is not limited to these several examples of preconditioning, as other aspects of preconditioning may be performed as well. These and other aspects will be discussed in greater detail below in connection with FIGS. 8-10.

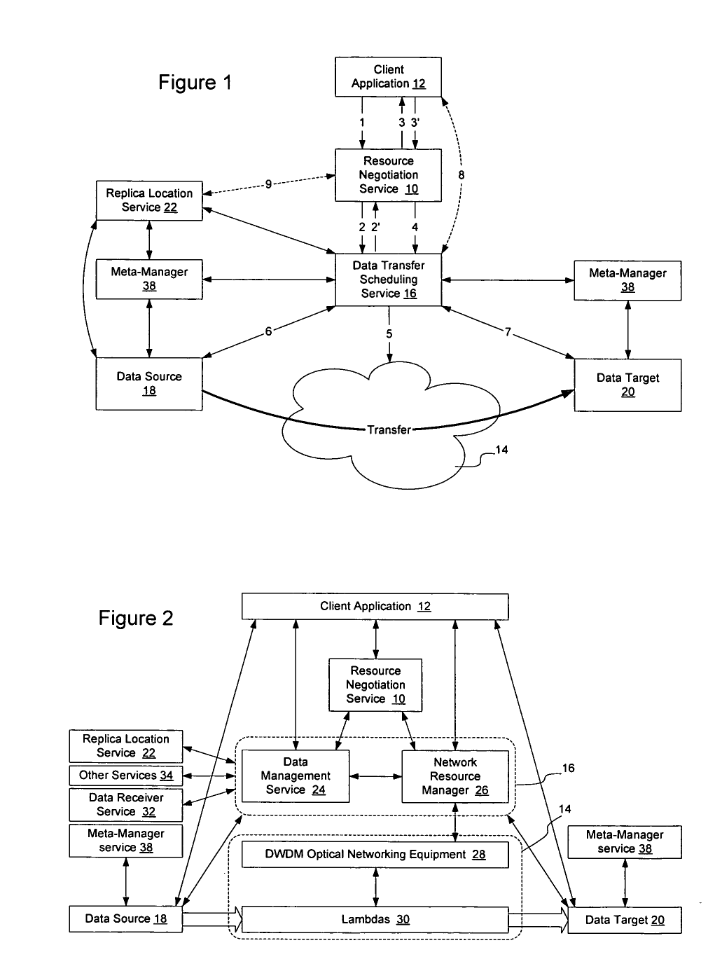

The data transfer scheduling service may take many different forms and may include multiple logical sub-components. An embodiment of the data transfer scheduling service will be provided in connection with FIGS. 2 and 3. The invention is not limited to use with this particular embodiment, however, as it may be used with other resource reservation services as well.

In the embodiment shown in FIGS. 2 and 3, the data transfer scheduling service is a system for scheduling and controlling high bandwidth wavelength-switched optical network connectivity to fulfill data transfer requests. The resource negotiation service 10 may advantageously interact with this embodiment or other embodiments to enable the wavelength switched optical resources to be obtained on demand and to enable business logic to be used to automatically negotiate reservation of those resources. As described in greater detail below, the data transfer scheduling service is a scheduled management system for application-level allocation in a switched network, which is an underlay for a packet network. In this embodiment, the system is configured to receive requests for switched network allocations with requested scheduling constraints, and responds with resource availability and scheduled reservations for the switched network resources. The data transfer scheduling services may also manage the data transfer and optionally provide data storage in connection with the data transfer. According to one embodiment of the invention, the data transfer scheduling server may allow data transfers to occur:
on demand (right now);
rigidly in the future (e.g., “tomorrow precisely at 3:30 am”);
loosely in the future (e.g., “Tuesday, after 4 pm but before 6 pm”); and
constrained by events (e.g., “after event A starts or event B terminates”);
   although many other types of reservations may be made as well, and the invention is not limited to a system that is able to implement these or only these particular types of network resource reservations. A reservation request that is not rigidly fixed with precise required parameters will be referred to herein as under-constrained. In this context, an under-constrained resource reservation request enables the request to be fulfilled in two or more ways rather than only in one precise manner.

The data transfer scheduling service enables network resource optimization to be performed taking into account the constraints set forth in the received requests. This may involve a callback system, where previously reserved network allocations are undone and rerouted and/or rescheduled in order to satisfy additional requests or higher priority or higher revenue requests received after the initial scheduling is completed. In this embodiment, the system notifies to the requesting client and asks it to reschedule a reservation. The client then agrees, by submitting a new request, relinquishing its existing reservation, or it may choose not to do so.

When a new request displaces a previously negotiated request, the data transfer scheduling service may optionally re-negotiate the new request. Where the price associated with the transfer changes, the network provider may consider the price increase when determining whether to displace the previously scheduled transaction. Optionally, the network operator may choose to honor the previously negotiated price, while rescheduling the previously scheduled request and attempt to find available resources to fulfill the request at as near to the previous price as possible. There are many different ways to renegotiate displaced previously scheduled requests and the invention is not limited by the particular business logic utilized in the renegotiation.

The scheduling module also includes hardware and software configured to enable it to query the network for its topology and the relevant characteristics of each segment. The information obtained from this process may be abstracted and presented to the resource negotiation service to enable it to have a consolidated view of the network. It may also include one or more routing modules to plan available and appropriate paths between requested endpoints in (or near) requested time windows, and the ability to allocate specific segment-by-segment paths between endpoints and to relinquish them when the data transfer is done or when the user decides to cancel a reservation or request.

The data transfer scheduling service also provides a higher-level service that manages data transfers using the bandwidth allocated by the lower-level service described above. This data transfer service interfaces with the data meta-manager service to pre-condition the data to be transferred and uses the reserved and scheduled network allocations to effect file transfers as specified by the clients' requests. The data transfer service has all the same scheduling characteristics as described above, and can do aggressive optimizations involving rescheduling within the boundaries of the previously requested reservation constraints. These transfers may use an underlying file transfer mechanism to complete the transfer using the reserved and allocated optical network. Several available transfer mechanisms include:
File Transfer Protocol (FTP);
GRIDftp;
Fast Active Queue Management Scaleable TCP (FAST);
TSUNAMI (a protocol that uses TCP for transferring control information and UDP for data transfer);
Simple Available Bandwidth Utilization Library (SABUL)—a UDP-based data transfer protocol;
Blast UDP;
Striped SABUL (P-SABUL); and
Psockets.
   Other transfer mechanisms may be used as well and the invention is not limited to an implementation that uses one of these several identified protocols.

The client application can request a transfer of a named data set between two computers or data systems, neither of which are associated with the client application. The data source system needs only to be running a server which can interact with the data transfer protocol used by the data target, e.g., ftp. The data target system needs to have a data receiver service daemon running to enable it to receive the data transfer. A meta-manager service may help manage data on one or more of the data source and data target systems, to enable the data to be pre-conditioned for transfer at the data source and to enable the data to be received and de-conditioned at the data target.

Additionally, the requesting client may not know where the data source actually resides on the network, or there may be replicas of the data that reside in a number of places on the network. The data transfer scheduling service may interact with a replica location service 22 to find the location(s) on the network of the actual files that make up the named data set. Then, the data transfer scheduling service may choose a convenient source location based on a number of factors, such as the physical proximity of the data source to the data target, the availability of the data source to fulfill the request, the cost associated with obtaining the data from the data source, the amount of pre-conditioning that will be required, the estimated time it will take to pre-condition the data, and many other factors. Optionally, after the data set has been moved, the replica location service may be notified that another copy of the data exists, and its location. One replica location service is currently being developed in connection with the GRID initiative. Optionally, feedback from the replica location service as to the availability of the data and the cost of obtaining the data from various sites at different times may influence the negotiation and hence may be communicated to the resource negotiation service either directly (arrow 9) or via the data transfer scheduling service 10. Similarly, feedback from the meta-manager service as to the amount of pre-conditioning required to prepare various data sets for transfer may be used to influence the negotiations and thus may be communicated to the resource negotiation service.

The resource negotiation service and data transfer scheduling service can be instantiated in many forms on the network, such as stand-alone Web Services, or as a Web Services configured to interact with other Web Services. For example, the resource negotiation service may interact with the data transfer scheduling service or may be formed as a component of the data transfer scheduling service. Similarly, the data transfer scheduling service may interact with other Web services, such as the data meta-manager service and other services configured to manage disk storage and those which manage computational resource availability, in order to coordinate all of these disparate resources to fulfill a submitted transfer request. In one embodiment, the resource negotiation service, the data transfer scheduling service, and the data meta-manager service are instantiated using the Globus Toolkit, such that components are configured with Open Grid Services Interface (OGSI) compliant application interfaces within the Open Grid Services Architecture (OGSA).

Embodiments of the resource negotiation service may provide one or more features, such as the ability to implement policy designed to optimize network utilization, enable resource allocation to be rescheduled, the ability to coordinate with client-side applications, and the ability to notify client-side applications of negotiation results and allocated resources or the need to renegotiate and reallocate resources. Additional or alternative features may be included as well and the invention is not limited to an embodiment providing this specific selection of features.

The data transfer scheduling service may include the ability to optimize fulfillment of requests and optimize network utilization based on the constraints contained within the requests and policy set on the resource negotiation service. This embodiment provides a framework that can be used to support other services, such as priority models, accounting services, and other embellishments. It may include a mechanism, for example, such as an ability to interface with a replica location service, for querying to find the most appropriate source for a requested data set when multiple mirror or replica copies are available.

The data transfer scheduling service may also be configured to provide a rescheduling facility. That is, it may be configured to receive requests to reschedule previously scheduled reservations, and respond with new scheduled reservations, which may or may not implement the requested rescheduling (the “new reservation” may be identical to the old one).

The data transfer scheduling service may also be configured to provide a notification facility. That is, a reservation request may include a client-listener provided for notification callbacks. The data transfer scheduling service, in this embodiment, may be configured to issue notifications of changes in the status of the scheduled reservation to be received by the client-listener.

The data transfer scheduling service may also be configured to provide facilities for client-side cooperative optimization. That is, a facility may be provided to send requests to the client-listeners for client-initiated rescheduling. In this embodiment, new reservation requests may be satisfied with the cooperation of another client, so that existing reservations may be rescheduled to accommodate new requests. Accordingly, cooperative rescheduling of previously granted reservations may be performed in order to accommodate reservation requests that cannot be otherwise satisfied, or to accommodate new higher priority requests. This cooperative rescheduling may involve a renegotiation under the direction of the resource negotiation service.

Another aspect of the data transfer scheduling service is a system for scheduled management of data transfers, with coordination of multiple resources such as storage, network, and computation. This aspect may be a client to the network management system configured to schedule network resources described above or may be an independent network service. Increased participation in the transfer, such as through preconditioning of the data to be transferred, may be a factor considered in the negotiation for the services and hence may be included in the request and accounted for by the resource negotiation service. For example, the management aspect of the data transfer scheduling service may be configured to interact with other resource managers as needed to coordinate other codependent resources such as storage and computation. The data transfer management system, in this case, receives requests with scheduling constraints which may be under-specified, and optimizes usage of network and storage resources globally, using the freedom afforded in the under-specification of the client requests to reschedule as needed. That is, the data transfer system reschedules activity while continuing to satisfy previous requests, using flexibility in the requested scheduling constraints to provide optimized resource utilization in the face of changing demands.

The resource negotiation service, according to an embodiment of the invention, enables bandwidth to be purchased as needed by end consumers or intermediate applications. By allowing users and programs to schedule and/or lease temporary bandwidth, it is possible to obtain bandwidth resources without requiring the users/programs to lease sufficient bandwidth to handle their peak bandwidth requirements. Additionally, because users are able to schedule bandwidth on demand, they can obtain the bandwidth they need on short notice without having to wait for a common carrier to set it up.

In one embodiment, a Web application is configured to interface with a human user that has accessed the web application using a web browser. The application of this embodiment allows the user to rent bandwidth between two or more points on the network for specific time periods, either for immediate use or for some time in the future.

In a second embodiment, a Web Service configured to interact with other computer programs is configured to enable bandwidth to be rented between two or more points on the network for a specific period of time, either for immediate use or for some time in the future. A Web Service, in this context, is a standard way of making an application available to another computer on a network. Web Service implementations are based on web server technology, but they use standard protocols to communicate what are essentially remote procedure call requests and responses, rather than browser input and screens for browser display.

Optionally, the web server providing the interface to the user over a web browser or to a computer program over a Web service interface is embedded in the switch and sold as part of the network element. This allows the owner of the network element to set up a rent-some-bandwidth web storefront without requiring the owner to understand the details of the underlying network control and/or management interfaces.

The resource negotiation service may be implemented as a software program product configured to implement one or more of the following features:
A facility allowing clients to lease or rent optical bandwidth to interconnect the client's computers.
A feature to enable Bandwidth to be purchased for immediate use, or for some future time.
A feature to enable Bandwidth to be purchased for different lengths of time.
A feature to enable Bandwidth to be available under one or more pricing schemes, depending on any number of factors, such as time of day or duration of the lease or rental.
A feature to enable Billing to be done electronically and automatically.
The program may be accessible over the Internet using a standard web protocol such as Hyper Text Transfer Protocol (HTTP) or a standard Web Services protocol such as Simple Object Access Protocol (SOAP).
The program may be invoked by human clients or by other programs.
   The invention is not limited to these particular features as the resource negotiation service may include numerous additional features as well.

FIG. 2 illustrates an architecture that may be used to implement an embodiment of the invention. As shown in FIG. 2, in this embodiment, client applications 12 interact with a data transfer scheduling service 16 having a data management service 24 and a network resource manager 26 to effect transfers of data between a data source 18 and a data target 20 over an underlay network 14. Interactions between the client and the data transfer scheduling service 16 may take place using a communication protocol such as Simple Object Access Protocol (SOAP), Extensible Markup Language (XML) messaging, Hyper Text Transfer Protocol (HTTP), Data Web Transfer Protocol (DWTP) or another conventional protocol.

A resource negotiation service 10 is included to interface between the client application 12 and the data transfer scheduling service to negotiate provision of network services to the client application. Alternatively, the resource negotiation service may be accessed by the data transfer scheduling service and not interface the client, to perform negotiation of services on behalf of the data transfer scheduling service 16 in a manner that is transparent to the client 12. The invention is not limited to the particular manner in which the resource negotiation service is implemented or which participants have access to it during the process of scheduling an allocation of resources on the network.

The underlay networks 14 are generally provided by Dense Wavelength Division Multiplexing (DWDM) optical networking equipment 28 that provides optical transmission capabilities over wavelengths (lambdas) 30 on optical fibers running through the network. The optical fiber network may also be used to carry packetized traffic when not reserved for data transmissions by the data transfer scheduling service. The underlay networks according to one embodiment are considered switched underlay networks because the reservations to be effected on these underlay networks for data transfer involve reservation of one or more lambdas on the network for a particular period of time. The underlay network hence appears as a switched network resource, rather than a shared network resource, since the network resource has been reserved for a particular transfer rather than being configured to handle all general packet traffic, as is common in a conventional shared network architecture.

As discussed in greater detail below, the network resource manager 26 provides scheduled management of raw network resources (i.e. lambda allocations in real time and scheduled for the future). This service is concerned only with network resources—not data management. The data management service 24 provides scheduled management of data transfer jobs. It makes direct use of the network resource manager, but also interacts with the replica locator service 22, data meta-manager service 38, data source 18 and data target 20 involved in the data transfer, as well as optionally other services such as a data receiver service 32 and other services 34 (described in greater detail below). To achieve optimal performance, the data management service 24 is tightly coupled to the network resource manager 26, although the network resource manager can be used by applications independently of the data transfer service.

In the architecture of FIG. 2, the network resource manager 26 is configured to interface multiple physical/logical network types interacting via multiple network interface and management protocols. The network resource manager performs topology discovery on the network to discover how the underlay network elements are configured and what resources are deployed throughout the network.

Network information received by the network resource manager is consolidated for presentation to the data management service 24. By consolidation, in this instance, is meant that the network resource manager consolidates information from the underlay networks and presents a single uniform view of them to the upper layers, (either the data management service or a directly accessing application). That is, the network resource manager abstracts the actual networks it is managing so that the upper layers do not need to be concerned with details not relevant to their models. For example, in topology discovery, a network of abstract nodes and links may be returned by the network resource manager to its caller in response to a request for topology discovery. In this regard, each node and link has a set of properties that may be relevant to doing routing for path allocation, etc. But those details not needed for these tasks may be hidden. Accordingly, the consolidation function serves to eliminate information that will not be pertinent to other modules when performing their assigned tasks, and may present disparately organized or formatted information in a common representation.

The network resource manager 26 also performs path allocation. Specifically, the network resource manager, in connection with topology discovery, may allocate paths through the network that will be used to effect transfers of data. The path allocation module, in addition to allocating paths, also effects reservations on the allocated paths so that the data receiver service (discussed below) can use the paths to effect the transfer of data between the data source and data target.

The network resource manager also includes the ability to perform scheduling and optimization of network resources. Unlike the data management service, the network resource manager performs scheduling on the network resources without consideration of the availability of the source and destination of the data. Network resources scheduled by the network resource manager are communicated to the data management service. Additionally, conflicts in reservations or the inability to fulfill a reservation is transferred to the data management service for scheduling optimization as discussed in greater detail below. By enabling the network resource manager to perform path allocation and scheduling, as well as network discovery, it is possible to enable the network resource manager to reserve resources directly on behalf of the client applications 12 in addition to through the cooperative interaction between the network resource manager and the data management service 24.

The data management service 24 supports topology discovery, route creation, path allocation, interactions with the data meta-manager service 38 and replica location service 22 and data transfer scheduling. The data management service is also the primary module to interface with the resource negotiation service, although the invention is not limited in this regard. The topology discovery function of the data management service receives abstracted network configuration information from the consolidation module in the network resource manager to have a high level view of the network that will be used to effectuate the data transfer. Interactions with the replica location service enable the data management service to locate an available source of the target data set. Interactions with the data meta-manager enable the data set to be pre-conditioned to be transferred on the scheduled resources. The data management service may use the information obtained from these sources to perform path allocation and make routing decisions as to how and when the data transfer is to take place on the network. These path allocations and routing decisions will be passed to the network resource manager in connection with a scheduled transfer and used by the network resource manager to reserve resources on the underlay networks. Information associated with the transfer may also be passed to the data meta-manager service to enable the data to be prepared to be transferred on the high bandwidth scheduled resources.

The data management service also includes a scheduler/optimizer that is configured to perform transfer scheduling and optimization as discussed above to schedule constrained and under-constrained data transfers requested by clients 12.

The data management service 24 interacts with one or more other service modules on the network to enable it to have access to advanced functions not directly configured in the data management service 24 or the network resources manager 26. Examples of other services that may be available (discussed in greater detail herein) include the resource negotiation service 10, the data replica location service 22, the data meta-manager service 38, a disk/storage service, Authentication Authorization and Accounting (AAA) services, security services, and numerous other services.

For example, a data replica location service 22 may be used to locate a source of data or to discern between available sources of data to select an optimal source of data as discussed above. An AAA service may be provided to enable the applications to be authenticated on the network, enable the network components such as the data management service and the network resource manager to ascertain whether the application is authorized to perform transactions on the network, and to allow accounting entries to be established and associated with the proposed transaction. The accounting service may be configured, in one embodiment of the invention, to interact with the resource negotiation service to electronically or automatically invoice subscribers for transactions performed on the network. For example, a negotiation may conclude with a scheduled reservation and a negotiated price. The price information may be passed to the accounting service, together with an indication of the reservation such as the reservation ID. When the transaction associated with the scheduled reservation occurs, the price information may be used to invoice the subscriber for the services.

Additionally, a security service may be interfaced to provide security in connection with the request or data transfer to enable the transaction to occur in a secure fashion and to enable the data to be protected during the transfer. For example, the security module may support the creation of Virtual Private Network (VPN) tunnels between the various components involved in securing the transfer of data across the network. Numerous other services may be performed as well and the invention is not limited to an architecture having only these several described services.

Data to be transferred on the network may be created and transferred in real time, for example by a bank of processing resources, or may exist as a data set in one or more storage systems. Conventional storage systems are able to output data at one or two orders of magnitude slower than the data may be transferred on the network. For example, a storage system may be capable of outputting data at 100 Mbps or up to about 1 Gbps. For example, current high end storage systems, such as EMC's Celerra Clustered Network Server™, while capable of storing in excess of 200 terabytes of data, is only provided with four 1 Gig-Ethernet network interface cards. However, the network may be capable of transferring data at in excess of 10, 100 or more Gbps. To prepare the data to be transferred, a data meta-manager service may precondition the data to make the data available to be transferred over the network.

FIG. 8 illustrates one embodiment in which a data meta-manager service 38 interfaces with a plurality of data storage subsystems 90 to enable the data to be pre-conditioned to be transported on the network 14. Specifically, in this embodiment, a data set to be transferred across the network is distributed to multiple storage subsystems 90 , each of which may spread the data across multiple discs or other storage resources 92, so that portions of the data may be read from multiple sources simultaneously, passed to an optical switch 28 having a high speed access to the scheduled resource, and multiplexed onto the switched underlay network. By preconditioning the data, e.g. by moving the data from one storage subsystem to a plurality of storage subsystems that may be used simultaneously, the data may be provided to be transferred at a much higher rate over the network. The transfers between the storage subsystems during the pre-conditioning phase may take place using slower speed links, e.g. 1 Gbps links between the storage subsystems. By pre-conditioning the data for transfer, slower rate data sources may be used to fill higher rate transport resources to thereby achieve a high effective data transfer rate of a target dataset. This becomes increasingly important when several optical lambdas are aggregated and the discrepancy between the data output rate available from one of the storage subsystems and the data transfer rate on the network increases.

Pre-conditioning may involve moving the data from one data source, for example one of the storage subsystems, to more than one subsystem. Additionally, pre-conditioning the data may involve moving the data to storage subsystems closer to the end of the resources on the switched underlay network that are to be scheduled for the data transfer. For example, particular data storage subsystems may be connected to the optical switch via dedicated 1 Gbps links whereas other storage subsystems may be connected to the optical switch only over a conventional packet network. By preconditioning the data to move it to the storage subsystems that have enhanced access to the network switch, the data may be provided to the switched underlay network at a higher rate from fewer storage subsystems.

For example, assume that a 1 terabit file is to be transferred from a data source to a data target on the network. At 20 gigabits per second, it will take 50 seconds to transfer the data. To pre-condition the data to be transferred, the 1 terabit file may be broken into 20 pieces, each of which may be stored on a separate storage sub-system having a 1 gigabit per second output data rate and a 1 Gbps link to an optical switch that will be used to interface the optical network resource during the file transfer. At the scheduled time, the storage subsystems will each begin reading out their portion of the file at 1 Gbps. The optical switch will multiplex the 20 data streams and insert the data onto the 20 Gbps optical resource that has been reserved for the transfer. In this manner, data may be transferred onto high bandwidth resources by preconditioning the data to be transferred and simultaneously reading the data from multiple sources.

The data meta-manager may retrieve data from the several storage subsystems in a predefined pattern, or may record the pattern in which data is multiplexed from the multiple data sources onto the optical link. To enable the data to be de-conditioned at the data target, whatever pattern is used should be communicated to the data target, for example via the data meta-manager service. Information about the manner in which data will be multiplexed onto the optical link for transmission over the switched underlay network may be communicated to the meta-manager service associated with the data target before transmission, during transmission, or after transmission, to enable the data to be reassembled on the data target.

The storage subsystems may be independent from the network optical switch, as illustrated in FIG. 8, or formed as part of the optical switch. Optionally, data may be buffered in storage attached to the optical switch and multiplexed onto the optical link once a particular quantity of data, or a data parcel, has accumulated in the cache from one of the storage subsystems. Additional details associated with parcel switching data through a network may be found in U.S. patent application Ser. No. 10/719,299, the content of which is hereby incorporated by reference.

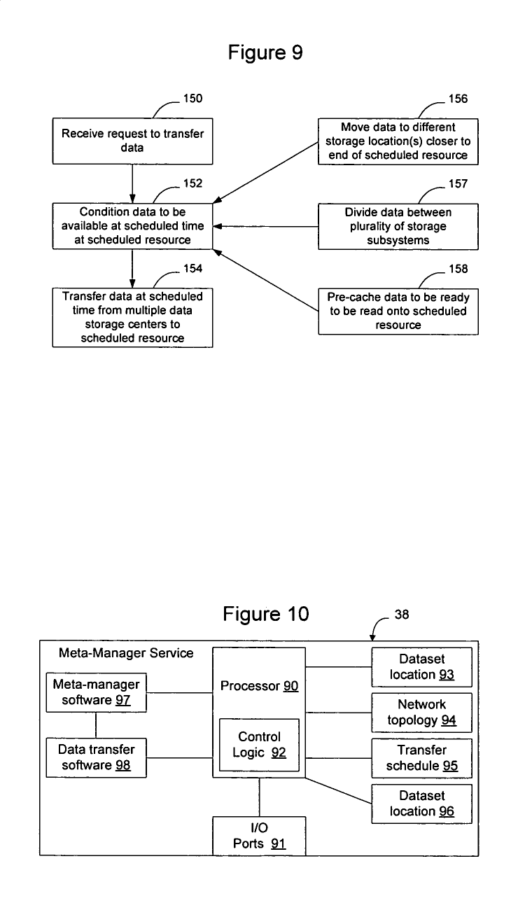

FIG. 9 illustrates a process of preconditioning data to be transferred using a data meta-manager service according to an embodiment of the invention. As shown in FIG. 9, when the data meta-manager receives a request to assist in a transfer (150), it conditions the data to be available at a scheduled time at a scheduled resource (152). This enables the right data to be ready at the right location at the right time. When the scheduled time occurs, the data is transferred at the scheduled time from multiple data source storage subsystems to the scheduled resource (154).

As discussed above, various aspects may be involved with conditioning the data to be available. For example, the data may be moved to one or more different storage locations closer to the end of the scheduled resource (156) so that they may be available to be transferred on the network. Closer, in this context, may mean physically or geographically closer to the optical switch, to a place that has a higher bandwidth connection to the optical switch, or which may otherwise provide advantageous transfer characteristics when it is time to transfer the data.

The data may also be divided between a plurality of storage subsystems (157) to enable the data to be read out of each of the storage subsystems simultaneously to increase the rate at which the data arrives at the optical switch and, hence, the rate at which the data may be multiplexed onto the reserved optical resource. Additionally, the data or a portion of the data may be pre-cached onto one or more high speed data caches (158) to enable the data to be provided to the scheduled resource at a higher rate.

In the several examples provided above, data is referred to as being spread across a number of storage subsystems, each of which has a number of banks of discs configured to store data. The storage subsystems may cause their portion of the data to be stored on the discs in any standard fashion, such as through the implementation of one or more Redundant Array of Independent Discs (RAID) algorithms that enable data to be stored within a subsystem to be stored in a reliable and efficient manner. The invention is not limited to a particular way of storing data within a data storage subsystem. Optionally, the meta-manager may break the data to be transferred into components using one of the RAID algorithms so that a nested RAID storage hierarchy may be used to store the data. Other manners of dividing the data between the storage subsystems may be used as well and the invention is not limited to this example.

Once a transfer has been scheduled and the bandwidth reserved on the network, the data receiver service 32 effects the transfer between the data source 18 and the data target 20. The transfer may use FTP, GRIDftp, SABUL, TSUNAMI, FAST, one of the transfer mechanisms mentioned above, or another convenient file transfer protocol. The data receiver service assists in the transfer of the data by checking to see if the source file exists, reporting on parameters associated with the source file such as its size and permissions, optionally checking with the data target to see if there is enough disk space to hold the transfer, interfacing with the data meta-manager service, causing the transfer to happen, reporting back on the status of the transfer when queried, and informing the data management service that a transfer has been completed or if a problem is encountered with the transfer. Other functions may be performed as well and this list of functions is intended merely as an example of some of the functions that may be performed by the data receiver service.

According to one embodiment of the invention, to make the components compatible with GRID computing technology, all application layer interfaces are configured to be OGSI compatible. This enables the network resource manager, data management service, data meta-manager service, other services, and data receiver services, to be treated as resources in a GRID computing environment so that they may be accessed by the applications either through GRID resource manager or directly in much the same way as an application would access other GRID resources.

FIG. 3 illustrates the network architecture of FIG. 2 in greater detail. As shown in FIG. 3, a client application 12 may send a request for data transfer between a data source 18 and a data target 20 to either the data management service 24 or the network resource manager 26. Alternatively, the client application 12 may send the request to a resource negotiation service 10 which, in this embodiment, may act as an interface to the network for the client application and may also negotiate on the client's behalf to secure switched underlay network resources to fulfill the request. The network resource manager and the data management service interoperate and have modules configured to perform any required network topology discovery, consolidation, route creation, path allocation, and scheduling, to ascertain availability of network resources and effect reservation of those network resources as discussed in greater detail above. Where network reservations are altered, due to scheduling conflicts, the network resource manager and data management service may also interoperate to effect a release of the reservation of the network resources.

In connection with this, the network resource manager may be required to interface with many different types of network resources and may need to communicate with the networks and network devices using a number of protocols. In FIG. 3, the network resource manager is illustrated as being configured to communicate with network devices using the following protocols:
User to Network Interface (UNI), a protocol developed to interface Customer Premises Equipment (CPE) such as ATM switches and optical cross connects with public network equipment;
General Switch Management Protocol (GSMP), a general Internet Engineering Task Force (IETF) protocol configured to control network switches;
Transaction Language 1 (TL1), a telecommunications management protocol used extensively to manage SONET and optical network devices;
Simple Network Management Protocol (SNMP), an IETF network monitoring and control protocol used extensively to monitor and adjust Management Information Base (MIB) values on network devices such as routers and switches;
Resource Reservation Protocol—Traffic Engineering (RSVP-TE), a signaling protocol used in Multi-Protocol Label Switching (MPLS) networks, that allows routers on the MPLS network to request specific quality of service from the network for particular flows, as provisioned by a network operator; and
Bandwidth Broker, an Internet2 bandwidth signaling protocol.
   Other conventional or proprietary protocols may be used as well, and the invention is not limited to these particular identified protocols.

Once network resources have been reserved, and the reservation is to be fulfilled, the data receiver service 32 manages the data transfer between the data source and the data target. As discussed above, the other services modules may be used to resolve replica data location, perform AAA services, and security services associated with this transaction.

An administrative client 36 may be provided to enable an administrative interface to the resource negotiation service 10, data meta-manager service 38, data management service 24, and/or network resource manager 26, to be used for example to set policy and other values, issue commands, control, and query the underlying services. The administrative client 36 may be used to set policy on the resource negotiation service to enable the resource negotiation service to properly price network services to fulfill requests. Ultimately, the pricing, and hence negotiation, of network services may include numerous aspects of business logic that will need to be conveyed to the resource negotiation service to enable the resource negotiation service to effectively negotiate with client applications. The policy values associated with the business logic, according to one embodiment of the invention, may be set by the network administrator or other operator through the administrative client 36.

The administrative client 36 may be used to perform various services on the several components to which it is interfaced. For example, on the data transfer scheduling service, the administrative client may be used to query the data management service, debug it, configure it, etc., while it is running. Thus, the administrative client may be able to obtain information from the data management service such as the jobs/routes scheduled for a particular client, jobs currently running, current topology model, current parameter list, and many other types of information. Additionally, the administrative client may be used to set values on the data management service, such as internal timeout parameters, the types of statistics the data management service is to generate, etc. The administrative client may also optionally interface with the network resource manager and other components of the service as well.

After completion of a transaction, reserved network resources are released. Optionally, where the network resources have been reserved for a set period of time, the network resources may be released automatically upon expiration of the set period of time. Completion of the transaction and/or release of the network resources may be communicated to the accounting module to enable an account associated with the transaction to be updated accordingly.

As discussed above and as shown in FIGS. 2 and 3, both the network resource manager and the data management service may be provided with the ability to schedule transactions on the network. The scheduling module may be configured in many different ways. For example, a request for a scheduled reservation within a specified window may be answered with a scheduled reservation during that window; a request for a reservation at a precise time can only be answered with a scheduled reservation at that time or failure. One reason for this constraint is that, in one embodiment, a scheduled reservation must fulfill the request and is not able to reserve resources to partially fulfill requests or to fulfill partial requests. Stated another way, in this embodiment a client always receives what it asks for, or nothing. In this embodiment, if the client's request is too constrained to be fulfilled, the client should make a less constrained or different request. In other embodiments a partial fulfillment of a request may be tolerated and the invention is not limited to this embodiment. The extent to which a client's request is required to be fully or partially fulfilled may be set by policy and may be taken into account during the negotiation process.

A requesting client application may be allowed to cancel a scheduled reservation after it has been granted, upon which the system will release the resources and then make them available to be reserved by other applications. Parameters, such as penalties or non-refundable deposits, associated with release of resources prior to use may be set by policy in the resource negotiation service to reflect the opportunity cost associated with making a reservation on the network. Specifically, making a reservation on the network may cause the network operator to turn away other requests that could have been used to fill the time slot allocated to the first request. When the reservation is canceled, the network operator may be unable to reallocate the resources to another request. This may be taken into account in the negotiation process and appear as one of the terms of the agreement associated with the reservation.

In general, there are two types of requests, under-constrained and fully-constrained. An under-constrained request may be satisfied in two or more ways, whereas a fully-constrained request may be only satisfied in one way. For example, a request may specify that it would be preferred that the transfer occur at a particular time or within a particular time frame, but that the request may be fulfilled at any time within a larger time window. Alternatively, the request may specify that the transfer should occur at the next available time. Additionally, the request may specify additional considerations, such as the cost of the transfer, additional time constraints and preferences, accounting information, and many other aspects associated with the proposed transfer. These parameters may be included in the negotiation process in addition to the scheduling process to enable the client application to convey specific policy information for that particular request, in addition to general policy information, to be used in the negotiation process.

The scheduled reservation will result in an allocation at the scheduled time. No further client action is needed to transform a scheduled reservation into an allocation; it happens automatically. If a special “allocation handle” or “resource ticket” is needed, then the client retrieves this from the network management service or data management service via push or pull. The scheduled reservation and/or allocation may be passed to the data meta-manager service 38, data receiver service 32, and or other components of the system to enable the transfer to occur at the scheduled time over the scheduled resources.

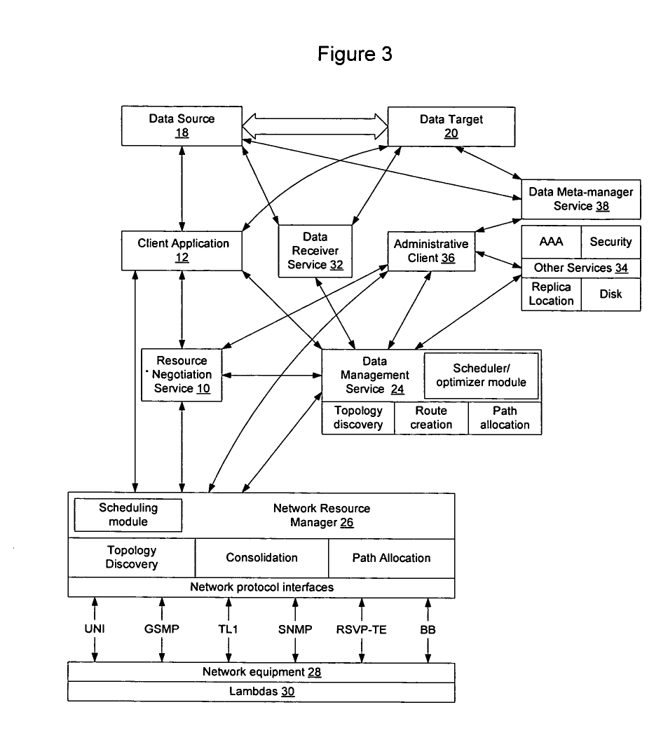

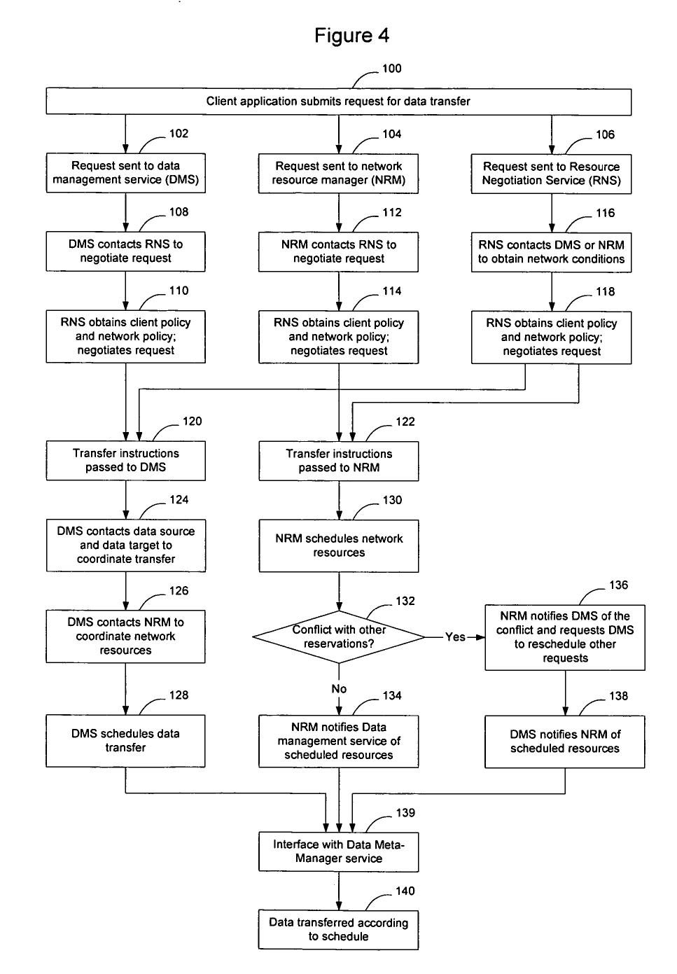

FIG. 4 illustrates a flow chart of an example of a how requests may propagate through the data transfer and scheduling architecture of FIGS. 1-3. As shown in FIG. 4, a client application submits a request for data transfer (100). This request may specify various parameters and policy values as discussed above, and will be sent to the data management service (102), the network resources manager (104), or the resource negotiation service (106). The request may also be sent to another construct on the network and the invention is not limited to an embodiment in which the request is sent initially to one of these three illustrated components.

If the request is sent to the data management service, the data management service will contact the resource negotiation service to negotiate the request (108). The resource negotiation service will obtain the client policy from the request or by interfacing with the client, and will also obtain the network policy information, optionally including network state information and availability of the data or the extent to which the data will need to be pre-conditioned from the data management service or one more other constructs on the network. Once the resource negotiation service has collected sufficient information it will negotiate the request (110).

If the request is sent to the network resource manager (104), the network resource manager will contact the resource negotiation service to negotiate the request (112). The resource negotiation service will obtain the client policy from the request or by interfacing with the client, and will also obtain the network policy information, optionally including network state information and availability of the data or the extent to which the data will need to be pre-conditioned, from the network resource manager or one or more other constructs on the network. Once the resource negotiation service has collected sufficient information it will negotiate the request (114).

If the request is sent directly to the resource negotiation service (106) the resource negotiation service will contact the data management service and/or network resource manager to obtain network state information and availability of the data or the extent to which the data will need to be pre-conditioned (116). The resource negotiation service will also obtain policy information associated with the request from the client and from the network, information relating to the data from the data meta-manager, and negotiate the request (118).

Once the request is negotiated, transfer instructions will be passed to the data transfer management service. As illustrated in FIG. 4, this may happen in two ways—by passing the transfer instructions to the data management service (120) or by passing the transfer instructions to the network resource manager (122). Optionally, the transfer instructions may be passed to both services. The transfer instructions may also be passed to the data meta-manager at this point (139) to enable the data meta-manager to begin preconditioning the data or, alternatively, may be passed to the data meta-manager service at another point in the process.

If the transfer instructions are passed to the data management service (120), the data management service will contact the data source and data target to coordinate the transfer (124). Optionally, this may be done via the data receiver service. The data management service will also contact the network resource manager to ascertain the availability of network resources (126). Contacting the data management service and network resource manager may occur serially or simultaneously and in any order. Upon receipt of all pertinent constraints, the data management service schedules the transfer (128) taking into account additional constraints imposed by other scheduled requests or requests that are also in the process of being scheduled. The data management service may also take into account the availability of the data, including whether the data needs to be preconditioned prior to being transferred, and the estimated amount of time it will take to precondition the data.

As illustrated in this embodiment, negotiation of a request may take other scheduled resources into account to enable network conditions to be included in the negotiation process. The transfer instructions, however, may also be under-constrained to allow the actual scheduling of the transfer to occur by the data management service or another construct on the network. For example, a client application may request a transfer of 100 Gbytes of data between 7:00 PM and 12:00 PM, at a cost not to exceed $100.00. During negotiation, the transfer may be negotiated to occur between 10:00 PM and 12:00 PM at a cost of $75.00. The actual scheduling of the request during the negotiated time period may be handled by the data management service given the new negotiated constraints.

If the request is sent to the network resource manager (122), the network resource manager ascertains the availability of the network resources and attempts to schedule the request by reserving available network resources to fulfill the request (130). The network resource manager also checks to see if the request conflicts with other reservations (132). If there is no conflict, the network resource manager notifies the data management service of the scheduled request (134) so that the data management service has knowledge of the scheduled request and can thus use that knowledge in connection with scheduling other requests. If the request conflicts with other reservations the network resource manager notifies the data management service of the conflict and requests the data management service to reschedule other requests or otherwise optimize scheduling of the request in view of the other contending requests (136). Once the data management service has scheduled/rescheduled requests, it notifies the network resource manager of the new schedule (138).

The responsible scheduling module, either in the data management service or the network resources manager, schedules the data transfer using the constraints in the request, the availability of the network resources, and the availability, or future availability, of the data and/or the capacity to receive the data. In connection with this, the network resource availability may be dependent on other requests. Accordingly, the responsible scheduling module will interrogate its scheduling tables to ascertain if another request can be moved to accommodate this request when the request is not able to be fulfilled on the network resources due to a scheduling conflict. Additionally, once a scheduled transfer has been accepted, it is included in the scheduling table along with any under-constrained parameters so that the scheduled transfer may be rescheduled at a later time if another request is unable to be fulfilled. The scheduled transfer may be communicated to the data meta-manager (139) at this point or any other point during the process to enable the data meta-manager service to begin pre-conditioning the data for transfer.

At the designated time, the scheduled request is fulfilled under the supervision of the data meta-manager service and data receiver service, which handle preparation of the data for transferal and coordination of the scheduled transfer between the data source and the data target (140). Other processes may be used as well and the invention is not limited to this particular process. The process illustrated in FIG. 4 may be implemented in hardware, software, firmware, or in numerous other manners and the invention is not limited to any particular implementation.

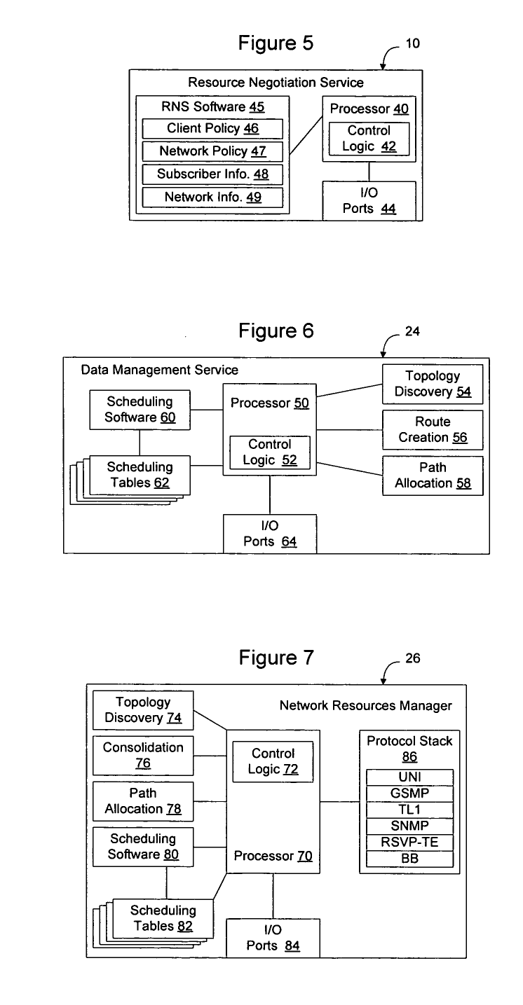

FIGS. 5-7 and 10 illustrate embodiments of a network element configured to implement the resource negotiation service 10, data management service 24, network resources manager 26, and data meta-manager service 38, according to an embodiment of the invention. These network services may be embodied in separate network elements, as illustrated, or two or more may be housed in the same network element and optionally the functionality of the elements may be combined to form one or more integrated services.

FIG. 5 illustrates an embodiment of the resource negotiation service according to an embodiment of the invention. As shown in FIG. 5, the resource negotiation service may be configured to be implemented on a network element including a processor 40 having control logic 42 configured to implement the functions ascribed to the resource negotiation service described herein. Alternatively, the resource negotiation service may be instantiated on a network element providing other services on the network and may be configured to run on the processor and control logic of the host network element. One or more input/output ports 44 may be provided to interface the resource negotiation service to the network to enable it to receive requests, issue transfer instructions, and otherwise communicate with the other constructs on the network.

The resource negotiation service may also include a resource negotiation service software package 45 containing one or more software modules (46-49) configured to assist the resource negotiation service in performance of one or more functions ascribed to it and described herein. For example, the resource negotiation software may include a client policy software module 46 configured to obtain, store, and manage client policy information. The client policy information may be obtained and relate to general standing policy instructions that may be broken down into numerous subcategories such as class of request, type of transfer, and in many other ways. The policy information may also relate to specific policy instructions for the particular request.

The resource negotiation service software module 45 may also include a network policy module 47 responsible for obtaining and maintaining policy information about the network. This policy information may contain pricing guidelines as to how requests for services should be priced, discounts that may be applied to customers, promotions or other incentives, and other network policy.

A subscriber information module 48 may be provided to maintain information about subscribers and to establish new accounts for new subscribers. Optionally, this module may maintain accounting information about the subscribers such as credit levels associated with the subscribers and policy information about how billing or other accounting entries should be handled for a particular subscriber. The subscriber information module may maintain other items of information that may be used to personalize the service for that particular subscriber as well and the invention is not limited to this particular example.

A network information module 49 may also be included to enable the resource negotiation service to maintain information about the network, such as an abstracted network topology, current and anticipated network conditions, network schedule information, and numerous other aspects of the network that may affect the negotiation, as discussed in greater detail herein.

Although several specific modules have been described herein in connection with the resource negotiation service, the invention is not limited to an embodiment that implements all of these modules or only these modules, as the resource negotiation service may be implemented in myriad other ways without departing from the scope of the invention.

In the embodiment of the data management service illustrated in FIG. 6, the data management service is configured to be implemented on a network element including a processor 50 having control logic 52 configured to implement the functions ascribed to the data management service discussed herein in connection with FIGS. 1-4. The network element has a native or interfaced memory containing data and instructions to enable the processor to implement the functions ascribed to it herein. For example, the memory may contain software modules configured to perform network topology discovery 54, route creation 56, path allocation 58, and scheduling 60. One or more of these modules, such as the scheduling software module 60, may be provided with access to scheduling tables 62 to enable it to read information from the tables and to take action on the tables, for example to learn of the existence of other scheduled reservations in connection with attempting to fulfill a reservation, and to alter existing reservations in connection with implementing or fulfilling a new reservation. I/O ports 64 are also provided to enable the network element to receive requests, issue instructions regarding fulfilled requests, and otherwise communicate with other constructs in the network.

In the embodiment of the network resources manager illustrated in FIG. 7, the network resources manager is configured to be implemented on a network element including a processor 70 having control logic 72 configured to implement the functions ascribed to the network resource manager discussed herein. The network element, in this embodiment, has a native or interfaced memory containing data and instructions to enable the processor to implement the functions ascribed to it herein. For example, the memory may contain software modules configured to perform network topology discovery 74, consolidation 76, path allocation 78, and scheduling 80. One or more of these modules, such as the scheduling software module 80, may be provided with access to scheduling tables 82 to enable it to take other scheduled reservations into account when attempting to fulfill a reservation. I/O ports 84 are also provided to enable the network element to receive requests, issue instructions regarding fulfilled requests, and otherwise communicate with other constructs in the network. A protocol stack 86 may be provided to enable the network resources manager to undertake protocol exchanges with other network elements on the network to enable it to perform network discovery and management, and to reserve resources on the network.

FIG. 10 illustrates an embodiment of the data meta-manager service according to an embodiment of the invention. As shown in FIG. 10, the data meta-manager service 38 may be configured to be implemented on a network element including a processor 90 having control logic 92 configured to implement the functions ascribed to the data meta-manager service described herein. Alternatively, the data meta-manager service may be instantiated on a network element providing other services on the network and may be configured to run on the processor and control logic of the host network element. One or more input/output ports 91 may be provided to interface the data meta-manager service to the network to enable it to interface with data sources, data targets, the data transfer scheduling service and resource negotiation service, and otherwise communicate with the other constructs on the network.

The data meta-manager service 38 may also include one or more software modules to enable it to participate in pre-conditioning data for transfer on the network. For example, as shown in FIG. 10, the data meta-manger service 38 may include a dataset location module 93 configured to contain information relating to the location of data to be transferred on the network, a network topology module 94 configured to contain information relating to the network topology over which the data will be transferred, and a transfer schedule module 95 configured to maintain information about scheduled transfers on the network. The data meta-manager service may also include a storage topology module 96 containing information about available storage systems that may be used to provide information about storage systems that may be used to precondition data to be transferred on the network.

The data meta-manager service 38 may also include data meta-manager software 97 and data transfer software modules 98 configured to interface with the data in the transfer schedule, network topology, dataset location, and storage topology modules, to enable the data meta-manager to control the storage subsystem's handling of the data to enable the data to be pre-conditioned for transfer. For example, in this embodiment, the data transfer software may receive scheduled transfer information from the transfer schedule module, ascertain the location of the data that will be transferred, determine where the transfer will occur and, form this information, determine how the data should be pre-conditioned to enable the transfer to take place. The data transfer software may then determine the storage topology associated with the storage subsystems where the data will be pre-conditioned.

The information relating to how the data will be pre-conditioned will be passed to the meta-manager software module that is configured to interact with the storage subsystems to rearrange the data to pre-condition it for transfer. The pattern used to rearrange the data during the pre-conditioning and/or the pattern used to read the data out to the optical switch may be specified by the meta-manager software module and communicated to the data target. The particular pattern used may depend on the type of optical switch used to put the data onto the optical resource, the type of storage subsystems, the presence of caching storage on the optical switch, and numerous other aspects of the transfer including the manner in which the data will be stored by the data target.

The control logic 42, 52, 72, 92 may be implemented as one or more sets of program instructions that are stored in a computer readable memory within or interfaced to the network element and executed on a microprocessor, such as processor 40, 50, 70, 90. However, in this embodiment as with the previous embodiments, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described herein may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

1. A method of preconditioning data to be transferred on a switched underlay network, the method comprising the steps of:
causing data to be moved from a first storage subsystem having a first data read rate to a plurality of second storage subsystems having a collective read rate of greater magnitude than the first data read rate; and
causing the data to be read out of the plurality of second storage subsystems at the collective read rate.

2. The method of claim 1, wherein the first read data rate is lower than a data transfer rate on the switched underlay network.

3. The method of claim 1, wherein the plurality of second storage subsystems comprises the first storage subsystem and additional storage subsystems.

4. The method of claim 1, wherein the data is provided to a network element configured to multiplex the data from the plurality of second storage subsystems onto the switched underlay network.

5. The method of claim 4, wherein the second storage subsystems are geographically closer to the network element than the first storage subsystem.

6. The method of claim 4, wherein the second storage subsystems are connected to the network element over links having a higher bandwidth than the first storage subsystem.

7. The method of claim 1, wherein the step of causing the data to be moved from the first storage subsystem comprises dividing the data into sections, and moving each of the sections to at least one of the second storage subsystems.

8. The method of claim 1, wherein the collective read rate is based on individual read rates of each of the second storage subsystems.

9. The method of claim 1, further comprising the step of defining a pattern for reading of the data from the plurality of second storage subsystems, and causing the pattern to be communicated to a target storage subsystem.

10. An apparatus for preconditioning data to be transferred on a switched underlay network, the apparatus comprising:
an interface to a storage subsystem containing a file to be transferred, the storage subsystem having a data output interface having a first data read rate;
control logic configured to generate instructions to the storage subsystem to cause the storage subsystem to transfer portions of the file to a plurality of second storage subsystems from which the data may be read at a collective data read rate greater than the first data read rate.

11. The apparatus of claim 10, wherein the control logic is further configured to generate instructions to define a pattern at which the data may be read from the second storage subsystems.

12. The apparatus of claim 10, wherein the instructions generated by the control logic cause the file to be divided into sections, each section of which comprises a portion of the file.

13. The apparatus of claim 10, wherein the portions of the file are copies of the file.

14. The apparatus of claim 10, wherein the control logic is further configured to generate instructions to a network element configured to transfer the data over reserved resources on the switched underlay network, the instructions comprising a multiplexing pattern relating to the data to be read from the second storage subsystems.

15. The apparatus of claim 14, wherein the instructions to the network element comprise buffering instructions as to how the network element should buffer the data prior to transmission on the reserved resources, and instructions as to the identity of the second storage subsystems that will provide data to be transferred on the reserved resources.
